(19) United States
(12) Patent Application Publication
(10) Pub. No.: US 2008/0041455 A1
(43) Pub. Date: Feb. 21, 2008

(54) Gas safety valve

(76) Inventor: Chi-Chen Hsiao, Chia Yi City (TW)

Correspondence Address: STITES & HARBISON PLLC, 1199 NORTH FAIRFAX STREET, SUITE 900, ALEXANDRIA, VA, 22314, US

(21) Appl. No.: 11/503,943

(22) Filed: Aug. 15, 2006

(51) Int. Cl. F16K 17/14

(52) U.S. Cl. 137/73

(57) ABSTRACT

A gas safety valve includes a main body having a first passageway, a second passageway, a third passageway, and a fourth passageway that have various inner diameters. Two ends of the second passageway are respectively in communication with the first passageway and the third passageway. The third passageway is in communication with the fourth passageway. A spring is mounted in the second passageway and longer than the second passageway. A ball is mounted in the third passageway and has a diameter larger than an inner diameter of the second passageway. A sealing ring and a restraining member are fixed in the fourth passageway. When gas flows from backward to the gas safety valve, the ball is pushed backward against the sealing ring and thus blocks a passageway of the sealing ring, preventing outflow of the gas.

### BACKGROUND OF THE INVENTION

1. Field of the Invention

The present invention relates to a gas safety valve and more particularly, to a gas safety valve mounted between a stove and a gas container to prevent gas leakage.

2. Description of the Related Art

U.S. Pat. No. 6,155,285 to Applicant discloses a gas safety valve. As illustrated in FIG. 1 of the accompanying drawings, the gas safety valve comprises a main body 1′, a meltable insert 6′, and a connector 5′ for coupling the main body 1′ to a valve seat 7′ of a gas container. When the ambient temperature rises to a predetermined magnitude due to e.g., a fire, the insert 6′ melts. The main body 1′ is urged by a valve stem 71′ under the action of an elastic member 73′ toward an outlet end, thereby moving the gas supply hole 72′ in the valve stem 71′ to a position not in communication with the gas source. Thus, gas supply is stopped.

The main body 1′ includes a plurality of gas passage sections 10′, 11′, and 12′ of various inner diameters. A spring 2′, a ball 3′, and a restraining member 4′ are mounted in the sections 11′ and 12′. When gas leakage occurs, the pressure difference between two sides of the ball 3′ forces the ball 3′ to move to a position blocking the section 11′.

Referring to FIG. 2, to avoid replacement of the gas container during cooking due to out of gas, two gas containers T1′, T2′ each having a gas safety valve V1′, V2′ of the above-mentioned structure are connected via hoses H1′ and H2′ to an automatic switch R′ that is connected to a stove B′. When the gas remaining in one of the gas containers (e.g., the gas container T1′) is lower than a predetermined amount, the automatic switch R′ closes the passageway from the gas container T′ to the stove B′, and gas is supplied from the gas container T2′ to the stove B′. The coupler 5′ can be turned to disengage the gas safety valve V1′ from the gas container T1′ after cooking. And the gas container T1′ is refilled at a gas station. If the gas safety valve V1′ is disengaged from the gas container T1′ during cooking, the automatic switch R′ cannot close the passageway from the gas container T1′ to the stove B′ when the output pressure of the gas container T2′ drops due to low gas remaining amount in the gas container T2′. Hence, the gas in the gas container T2′ will flow to the stove B′ and inflamed by the flames at the stove, leading to a fire. Namely, the conventional gas safety valve cannot reliably prevent outflow of gas.

### SUMMARY OF THE INVENTION

A gas safety valve in accordance with the present invention comprises a main body, a spring, a ball, a sealing ring, a restraining member, a connector, and an insert. The main body includes a flange on an outer circumference thereof. The main body is hollow and including a stepped structure having a first passageway, a second passageway, a third passageway, and a fourth passageway. The first passageway is an outlet end. The second passageway includes two ends respectively in communication with the first passageway and the third passageway. The third passageway is in communication with the fourth passageway.

The ball is mounted in the third passageway and has a diameter larger than an inner diameter of the second passageway. The spring is mounted in the second passageway and longer than the second passageway. The spring includes a first end restrained by the first passageway having an inner diameter smaller than a diameter of the spring. The spring further including a second end extending into the third passageway and abutting against the ball.

The sealing ring is fixed in the fourth passageway and adjacent to the third passageway. The sealing ring has a passageway with an inner diameter smaller that the diameter of the ball. The restraining member is fixed in the fourth passageway and adjacent to the sealing ring. The restraining member has a passageway. The restraining member has two ends respectively in communication with the passageway of the sealing ring and a valve seat of a gas container.

The connector includes a threaded section for coupling with the valve seat of the gas container. The connector includes a restraining end for receiving the main body. A meltable insert is mounted between the restraining end of the connector and the flange of the main body. The meltable insert has an appropriate rigidity and volume.

During use, gas is supplied from the gas container to the stove for cooking purposes. The meltable insert pushes a valve stem in the valve seat and thus opens a gas supply hole in the valve stem. The pressure difference between two sides of the ball is smaller such that the ball cannot compress the spring to seal the second passageway. Gas supply is normal.

When the ambient temperature rises to a predetermined magnitude, the meltable insert starts to melt. An elastic element in the valve seat pushes the valve stem and the main body away such that the gas supply hole is blocked. Thus, gas supply is stopped.

When gas leakage occurs at the hose at the outlet end of the main body, the large pressure difference between two sides of the ball pushes the ball to compress the spring and to block the second passageway, preventing further leakage.

When used with a gas supply system shown in FIG. 2, in a case that gas flows from the other gas container to the gas safety valve in accordance with the present invention, the ball is pushed backward against the sealing ring and thus blocks the passageway of the sealing ring, preventing outflow of the gas.

Other objectives, advantages, and features of the invention will become more apparent from the following detailed description when taken in conjunction with the accompanying drawings.

### BRIEF DESCRIPTION OF THE DRAWINGS

FIG. 1 is a partially sectioned side view of a conventional gas safety valve and a valve seat.

FIG. 2 is a schematic diagram of a conventional gas supply system having two gas containers.

FIG. 3 is a longitudinal sectional view of a gas safety valve in accordance with the present invention.

FIG. 4 is a partially sectioned side view of a valve seat and the gas safety valve in accordance with the present invention.

FIG. 5 is a view similar to FIG. 4, illustrating operation of the gas safety valve at high temperature.

FIG. 6 is a view similar to FIG. 4, illustrating operation of the gas safety valve under sudden pressure drop due to gas leakage.

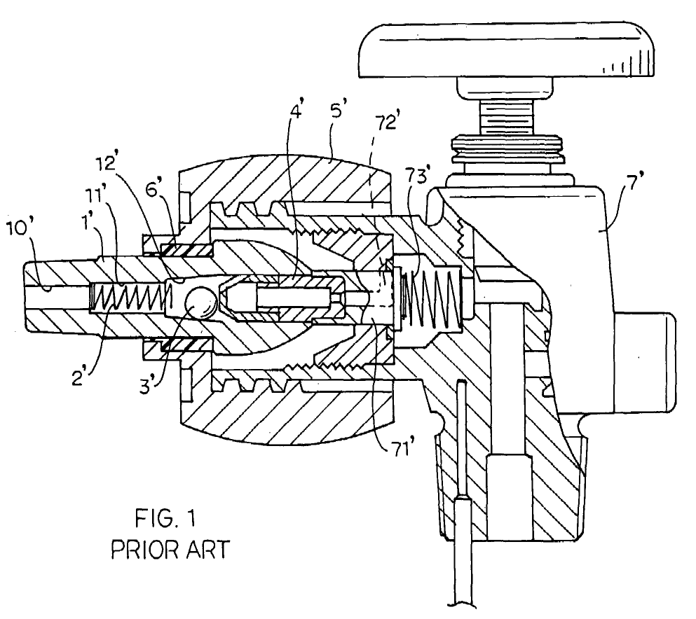

### DETAILED DESCRIPTION OF THE PREFERRED EMBODIMENT

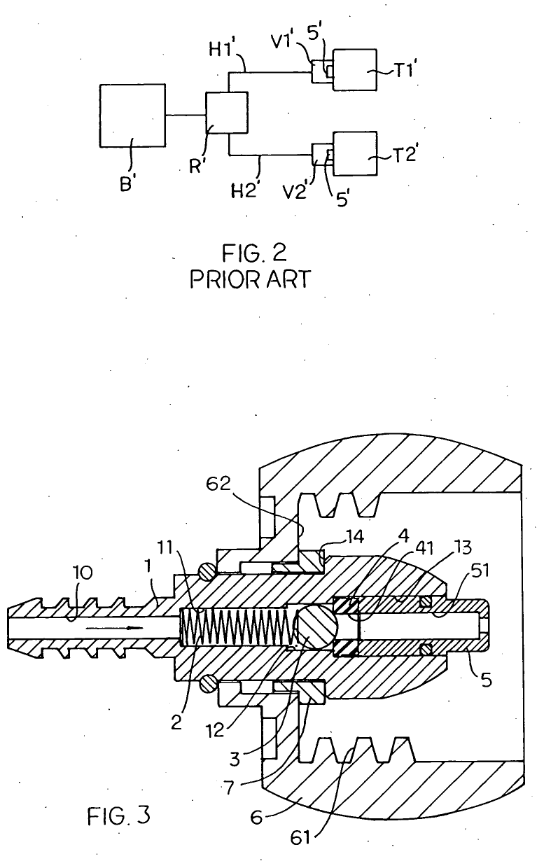

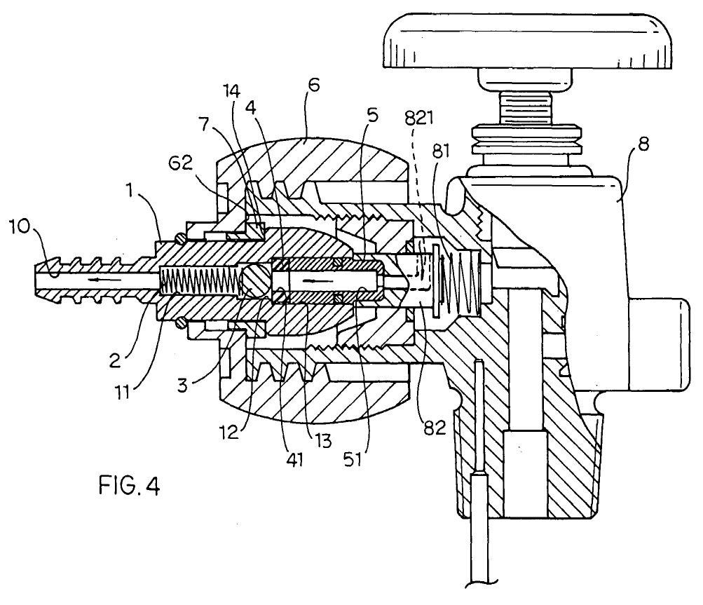

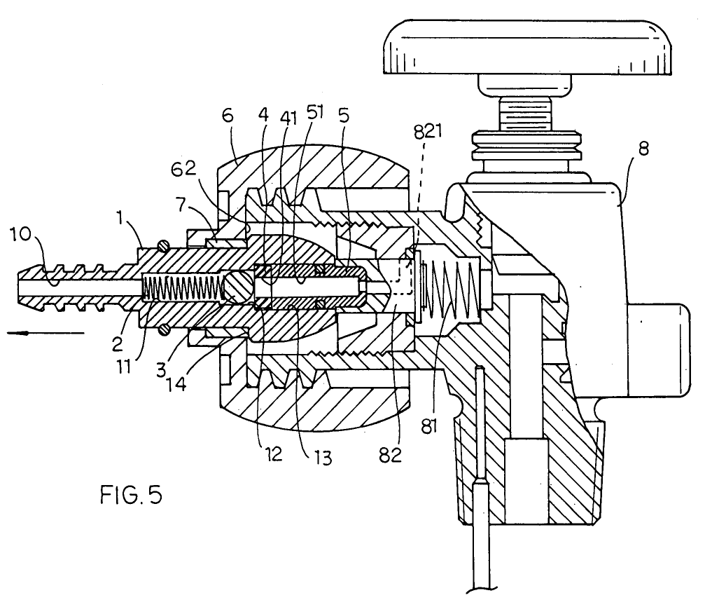

Referring to FIGS. 3 and 4, a gas safety valve in accordance with the present invention comprises a main body 1, a spring 2, a ball 3, a sealing ring 4, a restraining member 5, a connector 6, and a meltable insert 7.

The main body 1 includes a flange 14 on an outer circumference thereof. The main body 1 is hollow and includes a stepped structure having a first passageway 10, a second passageway 11, a third passageway 12, and a fourth passageway 13. The first passageway 10 is the outlet end and in communication with a hose (not shown) connected to a stove (not shown). Two ends of the second passageway 11 are in communication with the first passageway 10 and the third passageway 12 respectively. The third passageway 12 is in communication with the fourth passageway 13. A spring 2 is mounted in the second passageway 11 and longer than the second passageway 11. An end of the spring 2 is restrained by the first passageway 10 that has an inner diameter smaller than a diameter of the spring 2. The other end of the spring 2 extends into the third passageway 12 and abuts against the ball 3. The sealing ring 4 is fixed by tight fitting in the fourth passageway 13 adjacent to an end of the third passageway 12. The sealing ring 4 has a passageway 41. The diameter of the ball 3 is greater than the inner diameter of the second passageway 11 and the inner diameter of the passageway 41 of the sealing ring 4. Namely, the ball 3 is capable of blocking the second passageway 11 and the passageway 41 of the sealing ring 4.

The restraining member 5 is fixed by tight fitting in the fourth passageway 13 and adjacent to the sealing ring 4. The restraining member 5 includes a passageway 51 having two ends respectively in communication with the passageway 41 of the sealing ring 4 and a valve seat 8 of a gas container (not shown).

The connector 6 includes a threading portion 61 for coupling with the valve seat 8 of the gas container. The connector 6 has a restraining end 62 for receiving the main body 1. Mounted between the restraining end 62 of the connector 6 and the flange 14 of the main body 1 is the meltable insert 7 with an appropriate rigidity and volume. The meltable insert 7 is made of plastic material such as high-density polyethylene and meltable at about 116-149° C. After melting, the meltable insert 7 no longer abuts against the body 1.

Referring to FIG. 4, during use, gas is supplied from the gas container to the stove for cooking purposes. The meltable insert 5 pushes a valve stem 82 in the valve seat 8 and thus opens a gas supply hole 821 in the valve stem 82. The pressure difference between two sides of the ball 3 is smaller such that the ball 3 cannot compress the spring 2 to seal the second passageway 11. Gas supply is normal.

Referring to FIG. 5, when the ambient temperature rises to a predetermined magnitude, the meltable insert 7 starts to melt. An elastic element 81 in the valve seat 8 pushes the valve stem 82 and the main body 1 away such that the gas supply hole 821 is blocked. Thus, gas supply is stopped.

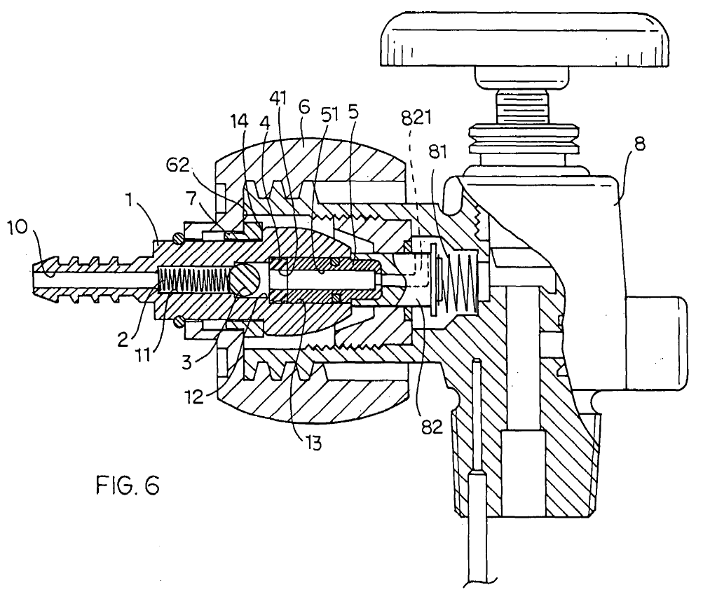

Referring to FIG. 6, when gas leakage occurs at the hose at the outlet end of the main body 1, the large pressure difference between two sides of the ball 3 pushes the ball 3 to compress the spring 2 and to block the second passageway 1, preventing further leakage.

Referring to FIG. 3, when used with a gas supply system shown in FIG. 2, in a case that gas flows from the other gas container to the gas safety valve in accordance with the present invention, the ball 3 is pushed backward against the sealing ring 4 and thus blocks the passageway 41 of the sealing ring 4, preventing outflow of the gas.

Although a specific embodiment has been illustrated and described, numerous modifications and variations are still possible without departing from the invention. The scope of the invention is limited by the accompanying claims.

What is claimed is:

1. A gas safety valve comprising:
a main body including a flange on an outer circumference thereof, the main body being hollow and including a stepped structure having a first passageway, a second passageway, a third passageway, and a fourth passageway, the first passageway being an outlet end, the second passageway including two ends respectively in communication with the first passageway and the third passageway, the third passageway being in communication with the fourth passageway;
a ball mounted in the third passageway, the ball having a diameter larger than an inner diameter of the second passageway;
a spring mounted in the second passageway, the spring being longer than the second passageway, the spring including a first end restrained by the first passageway having an inner diameter smaller than a diameter of the spring, the spring further including a second end extending into the third passageway and abutting against the ball;
a sealing ring fixed in the fourth passageway and adjacent to the third passageway, the sealing ring having a passageway, the diameter of the ball being larger than an inner diameter of the passageway of the sealing ring;
a restraining member fixed in the fourth passageway and adjacent to the sealing ring, the restraining member having a passageway, the passageway of the restraining member having two ends respectively in communication with the passageway of the sealing ring and a valve seat of a gas container; and
a connector including a threaded section for coupling with the valve seat of the gas container, the connector including a restraining end for receiving the main body, a meltable insert being mounted between the restraining end of the connector and the flange of the main body, the meltable insert having an appropriate rigidity and volume.
